(19) United States
(12) Patent Application Publication
(10) Pub. No.: US 2008/0211297 A1
(43) Pub. Date: Sep. 4, 2008

(54) Pneumatic Braking System for a Commercial Trailer

(75) Inventor: Denis Battistella, Paderno Dugnano (Milano) (IT)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Knorr-Bremse Sistemi Per Autoveicoli Commerciali S.p.A., Arcore (Milano) (IT)

(21) Appl. No.: 11/996,391

(22) PCT Filed: Jul. 25, 2006
(86) PCT No.: PCT/IB2006/052541

§ 371 Date: Jan. 22, 2008

(30) Foreign Application Priority Data
Jul. 25, 2005 (IT) TO2005A000510

(51) Int. Cl. B60T 8/36

(52) U.S. Cl. 303/118.1

(57) ABSTRACT

The system comprises
a brake cylinder with incorporated spring brake (1), associated with each wheel of at least one axle and able to perform air braking when both its inlets (1a, 1b) are under pressure, spring braking when a second inlet (1b) thereof is discharged, and release of spring braking when pressurised air is supplied again to the second inlet (1b);
a valve control unit (7) including a relay valve (8) having a control inlet (8a) connected to the air line or pipe (3) for braking while parking, a further inlet (8b) connected to the first line or pipe (2) for service braking, and an outlet (8c) connected to the first inlet (1a) of the brake cylinder (1) associated with each wheel of said at least one axle; and
a double non-return valve (11) having a first and a second inlet (11a, 11b) connected to the outlet (8c) of the relay valve (8) and, respectively, to the service braking line or pipe (2), and the outlet (11c) connected to the first inlet (1a) of the abovementioned brake cylinders (1).

The present invention relates to an air braking system for a towed commercial vehicle, such as a trailer or a semi-trailer.

One object of the invention is to propose an air system which, in particular as regards parking and emergency braking, has a simplified control structure and operates in an extremely reliable manner.

This object, together with other objects, is achieved according to the invention by an air braking system, the main characteristic features of which are defined in the accompanying claim 1.

Further characteristic features and advantages of the invention will emerge from the detailed description which follows, provided purely by the way of a non-limiting example, with reference to the accompanying drawings, in which:

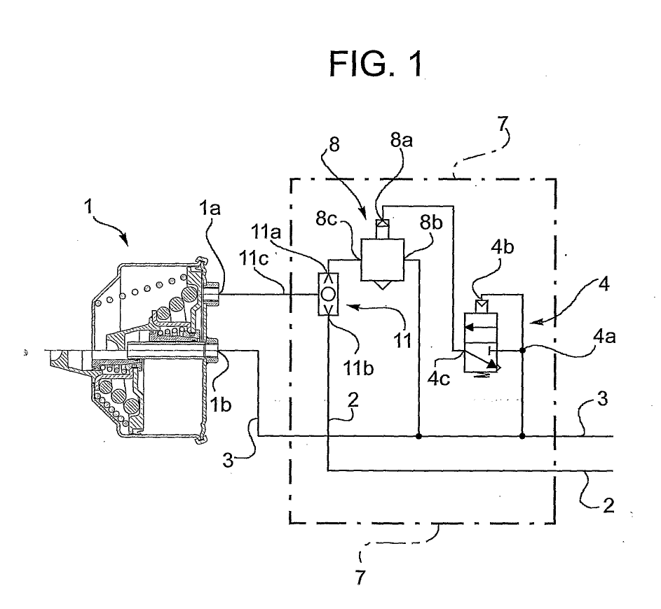

FIG. 1 is a diagram of an air braking system according to the present invention;

FIG. 2 is a cross-sectional view of a brake cylinder with incorporated spring brake contained in a braking system according to the invention, this brake cylinder being shown in two different operating conditions;

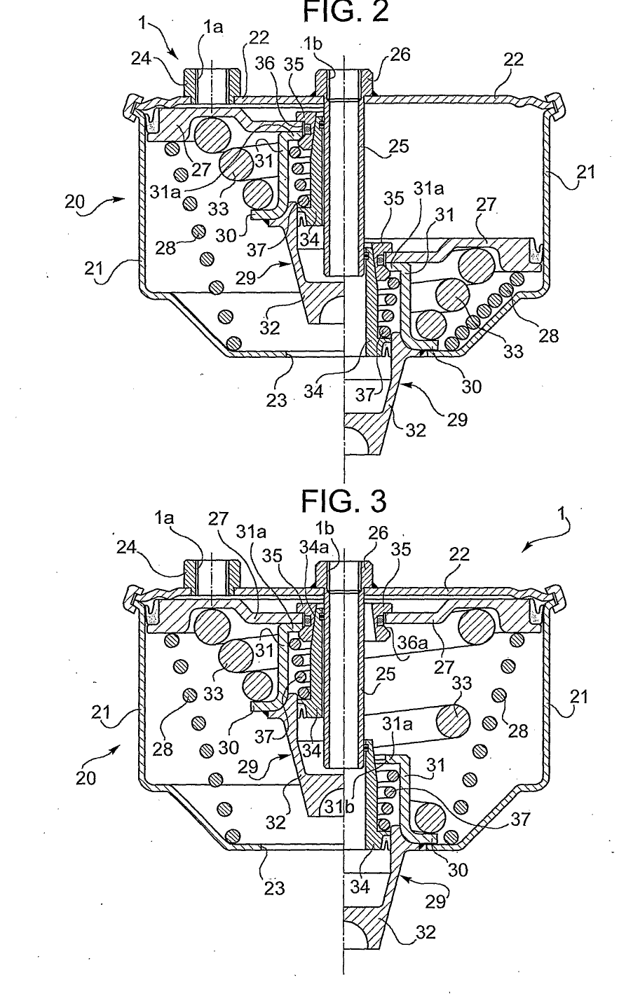

FIG. 3 is a cross-sectional view similar to that of FIG. 2 and shows the brake cylinder with incorporated spring brake in two different operating conditions;

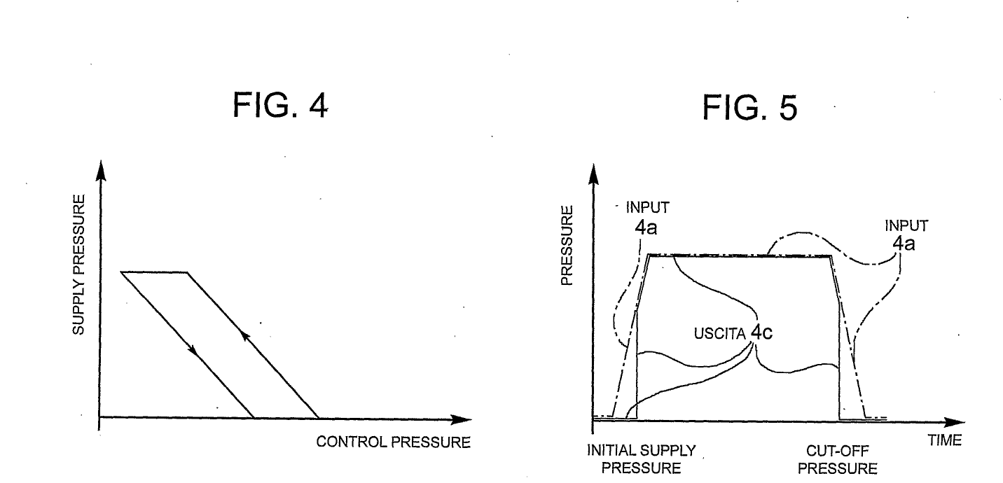

FIGS. 4 and 5 are diagrams which show characteristics of a relay valve and a pressure stop valve contained in a braking system according to the invention; and

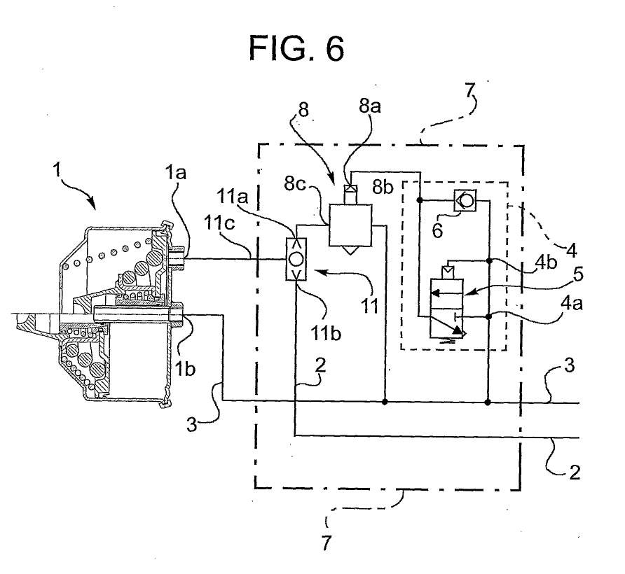

FIG. 6 is a diagram of a variation of embodiment of a braking system according to the invention.

With reference to FIG. 1, in a first embodiment an air braking system according to the invention for a towed vehicle comprises for each wheel of at least one axle a respective brake cylinder with incorporated spring brake, denoted overall by 1. A (non-limiting) embodiment of this brake cylinder will be described in detail below with reference to FIGS. 2 and 3.

The braking system shown in FIG. 1 comprises in a manner known per se a line or pipe 2 for service braking and a line or pipe 3 for parking and emergency braking.

The system also comprises a valve control unit denoted overall by 7.

In the embodiment shown by way of example in FIG. 1, this valve control unit 7 comprises a relay valve 8 having a negative control inlet 8a connected to the line or pipe 3 for control of parking and emergency braking by means of a stop valve 4 and a supply inlet 8b connected directly to the line or pipe 3.

The valve control unit 7 also comprises a double non-return valve 11 which has an inlet 11a connected to the outlet 8c of the relay valve 8, a second inlet 11b connected to the line or pipe 2, and an outlet 11c connected to a first inlet 1a of the brake cylinder with incorporated spring brake 1 of each wheel of said at least one axle of the vehicle. Each of these brake cylinders 1 also has a second inlet 1b connected directly to the line or pipe 3.

With reference to FIGS. 2 and 3, each brake cylinder with incorporated spring brake 1 comprises a rigid casing 20 including essentially a cup-shaped body 21, on the edge of which a lid 22 is sealingly engaged. A central opening 23 is formed in the bottom wall of the cup-shaped body 21. An inlet union 24, which constitutes the inlet 1a of the brake cylinder, is fixed inside a first opening of the lid 22. A tube 25 is fixed inside a further central opening of the lid 22 and extends axially inside the casing 20. A union 26, which forms the second inlet 1b of the brake cylinder 1, is connected to this tube 25.

A main piston 27 is slidably mounted inside the casing 20, and in particular inside the cup-shaped body 21. A spring 28 is arranged between the bottom wall of the cup-shaped body 21 and the main piston 27 and tends to push the latter towards the lid 22.

A shaped hollow body 29 which has an intermediate, outer, radial flange 30 is displaceably mounted underneath the main piston 27 inside the body 21. In the embodiment shown by way of example the body 29 is formed by an upper tubular element 31 and by a bottom cup-shaped element 32 which are welded together.

A helical spring 33 is arranged between the main piston 27 and the flange 30 of the body 29 and tends to push the latter downwards.

A tubular piston 34 is sealingly slidably mounted around the tube 25. The bottom end of this piston is sealingly slidably mounted within the top portion of the cup-shaped element 32. The top end of the piston 34 has an upwardly converging, frustoconical, outer, side surface 34a able to engage with and in particular wedge itself inside a coupling ring 35.

The ring 35 is formed so that it is radially expandable and contractible.

The main piston 27 has a central opening coaxial with the tube 25, and the coupling ring 35 has a peripheral annular seat 36 in the manner of a groove able to receive the edge of the piston 27 surrounding said opening as well as a corresponding top edge portion 31a of the tubular element 31 of the shaped body 29. This edge portion 31 of the tubular element 31 is directed radially towards the axis of the tube 25 and has, viewed in cross-section, an inclined end chamfer indicated by 31b in the right-hand part of FIG. 3. Correspondingly, the bottom portion of the seat 36 of the coupling ring 35 has, viewed in cross-section, an inclined side, indicated by 36a in the right-hand portion of FIG. 3.

A helical spring 37 is arranged between the top edge portion 31a of the shaped body 29 and the axially lower portion of the inner piston 34.

In a manner not shown, the shaped member 29 is coupled with braking elements (not shown) associated with a wheel of the front axle of the drive system. As will appear more clearly from below, the shaped body 29 is movable between a rest position, shown in the left-hand portions of FIGS. 2 and 3, where it disables braking of the corresponding wheel, and a working position, shown in the right-hand portions of FIGS. 2 and 3, where it causes braking of this wheel.

The brake cylinder 1 described above operates essentially in the following manner.

### Travel (Drive) Condition

When the vehicle is in the normal travel condition, no pressurised air is present at the inlet 1a, while instead pressurised air is present at the inlet union 1b. In this condition, the device assumes the condition shown in the left-hand portions of FIGS. 2 and 3: the tubular piston 34 is pushed pneumatically upwards and its top end portion engages inside the coupling ring 35 which is in the radially expanded condition and locks together the upper piston 27 and the shaped body 29. The assembly formed by this piston 27 and by the body 29 is kept in the position shown as a result of the action of the spring 28. The middle spring 33 is compressed.

### Service Braking

In order to activate service braking, pressurised air is supplied to the inlet 1a. Pressurised air is likewise supplied to the inlet 1b. During service braking the device assumes the configuration shown in the right-hand portion of FIG. 2: the pressure exerted on the upper side of the piston 27 results in the downward movement of the assembly formed by this piston, by the shaped body 29, by the spring 33 situated between them, by the tubular piston 34 and by the spring 37. The displacement of the shaped body 29 causes a corresponding activation of the braking devices associated with the corresponding wheel.

### Parking Brake

The transition from the travel condition into the parking brake condition is performed by discharging the pressure present at the inlet 1b. Pressure may or may not be present at the inlet 1a. The device 1 assumes the condition shown in the right-hand portion of FIG. 3: discharging of the pressure at the inlet 1b allows the spring 37 to push downwards the tubular piston 34, the top end of which therefore disengages from the coupling ring 35; the middle spring 33 may then push downwards the shaped body 29, the top edge 31a of which manages to release itself from the ring 35 which is radially yielding under compression. The ring 35 remains “fastened” to the main piston 27, while the assembly formed by the body 29, the tubular piston 34 and the spring 37 arranged between them moves downwards under the action of the spring 33, activating the positioning or parking brake.

### Release of the Parking Brake

In order to release the parking brake it is necessary initially to apply air under pressure to the inlet 1a: the top piston 27 therefore moves downwards against the action of the spring 28, transporting with it the coupling ring 35. When the piston 27 reaches the position shown in the right-hand portion of FIG. 2, the ring 35 fits again onto the frustoconical portion of the tubular piston 34 and engages again underneath the top edge 31a of the element 31 of the shaped body 29. This body 29 is again axially locked to the main piston 27. At this point, the inlet 1b is pressurised, the pressure at the inlet 1a is discharged and the main piston 27 returns upwards under the thrust of the spring 28 and the assembly assumes again the condition shown in the left-hand portions of FIGS. 2 and 3.

As already mentioned further above, the control inlet 8a of the relay valve 8 is connected to the line 3 via the stop valve 4. This valve in the embodiment according to FIG. 1 is of the three-way, dual-position, normally closed type, with an inlet 4a connected to the line or pipe 3, and with the outlet connected to the control inlet 8a of the relay valve 8. The stop valve 4 has a control inlet 4b connected to the inlet 4a. In this way the valve 4 is driven by the pressure of the air in the line or pipe 3. When the pressure at its driving inlet 4b is higher or lower than a predefined value, the valve 4 allows or prevents, respectively, connection of the line 3 to the inlet 8a of the relay valve 8.

The stop valve 4 associated with the relay valve 8 allows delaying in release of the service brake when the vehicle starts up with the pressurised air tanks completely or almost completely empty.

FIG. 4 illustrates, from a qualitative point of view, the characteristic curve for supply pressure against control pressure in respect of the valve control unit 7 including the relay valve 8.

FIG. 5 shows the characteristic curve for pressure against time in respect of the stop valve 4.

The air braking system described above with reference to FIG. 1 functions essentially in the following manner.

### Travel (Drive) Condition

In this condition, the pipe, 2 for service braking is not pressurised, while the pipe 3 is pressurised.

Consequently, the outlet 8c of the relay valve 8 is not pressurised. The inlet 1a of the brake cylinders 1 is not pressurised and the inlet 1b thereof is pressurised.

### Parking Brake

During braking while parking the line or pipe 3 is discharged, as is also the line or pipe 2.

There is no pressure at the inlets 1a and 1b of the brake cylinders 1.

FIG. 6 shows a variation of embodiment of the braking system described above in relation to FIG. 1. In FIG. 6, parts and elements already described have again been assigned the same reference numbers used above.

Compared to the system shown in FIG. 1, the system according to FIG. 6 differs essentially with regard to the following aspects.

The stop valve 4 in FIG. 1 is replaced by a valve unit, likewise indicated by 4 in FIG. 6 and comprising a two-way, dual-position valve 5 and, in parallel with the latter, a non-return valve 6.

The mode of operation of the system according to FIG. 6 is similar to that of the system according to FIG. 1.

Obviously, without modifying the principle, the embodiments and the constructional details may be widely varied with respect to that which has been described and illustrated purely by way of a non-limiting example, without thereby departing from the scope of the invention, as defined in the accompanying claims.

1. Air braking system for a towed commercial vehicle provided with a first air line or pipe (2) for service braking and a second air line or pipe (3) for braking while parking, the system comprising
a brake cylinder with incorporated spring brake (1), associated with each wheel of at least one axle of the vehicle and having a first and a second inlet for pressurised air (1a, 1b),
said brake cylinder (1) being able to perform air braking when both said inlets (1a, 1b) are under pressure, spring braking when the abovementioned second inlet (1b) is discharged, and release of the spring braking when pressurised air is supplied again to the second inlet (1b);
a valve control unit (7) including a relay valve (8) having a control inlet (8a) connected to said second air line or pipe (3), a further inlet (8b) connected to said first air line or pipe (2), and an outlet (8c) connected to the abovementioned first inlet (1a) of the brake cylinder (1) associated with each wheel of said at least one axle; and
a double non-return valve (11) having a first and a second inlet (11a, 11b) connected to the outlet (8c) of said relay valve (8) and, respectively, to said first air braking line or pipe (2), and the outlet (11c) connected to the first inlet (1a) of the abovementioned brake cylinders (1) of the wheels of said at least one axle.

2. Air braking system according to claim 1, in which the control inlet (8a) of said relay valve (8) is connected to the abovementioned second air line or pipe (3) by means of a pressure stop valve unit (4) driven by the pressure of the air in said second air line or pipe (3).

3. Air braking system according to claim 2, in which the pressure stop valve unit (4) comprises a three-way, dual-position valve.

4. Air braking system according to claim 2, in which the pressure stop valve unit (4) comprises a two-way, dual-position valve (5) and a parallel one-way valve (6).
